(19) United States
(12) Patent Application Publication
(10) Pub. No.: US 2003/0188523 A1
(43) Pub. Date: Oct. 9, 2003

(54) Adjustable push and pull rake

(76) Inventor: Giovanni Geremia, Winnipeg (CA)

Correspondence Address: GIOVANNI GEREMIA, 351 ASSINIBOINE AVE, WINNIPEG, MB, R3C 0X9, CA

(21) Appl. No.: 10/389,588

(22) Filed: Mar. 17, 2003

(30) Foreign Application Priority Data
Apr. 8, 2002 (CA) 2,380,547

(51) Int. Cl. A01D 7/00

(52) U.S. Cl. 56/400.01

(57) ABSTRACT

The invention provides an improvement to the common leaf and lawn rake in that, with a simple adjustment, the rake can be converted from a pull type rake to a push type rake. The pull rake is required in some circumstances where pushing is not practical. However, being able to adjust the pull rake to a push rake, and any angle in between, gathering leafs or debris of the like will require much less energy and less dexterity. The combination of being able to pull or push the rake so that the tines interact with the ground the same in either mode, enables the user to fully and efficiently clean an area by being able to access all areas and expanding the least amount of energy during the cleaning process.

This invention provides an improved hand rake that can be used by pulling it and, with a simple adjustment, it can be converted to a rake that is used by pushing it. The flexible tines of the rake provide the efficient raking action since they interact with the ground surface in a similar angle and manner regardless of whether the rake is being pulled or pushed. Pulling and pushing the rake provides the maximum flexibility in the process of cleaning a lawn or yard with the minimum exertion of energy.

### BACKGROUND TO THE INVENTION

Considered broadly, the fan shaped lawn and yard rake has been, and is, widely used. These rakes are generally designed to perform raking action by a pulling motion. The pull raking operation requires considerable energy and takes considerable time. The pull rake operation also requires a certain amount of exertion that some people, such as the elderly and handicapped are not able to use in cleaning the yard. Also, extended use of the pull rake becomes a strenuous chore even for those who are fit. A pushing motion requires the exertion of less energy. Being able to adjust the “angle of attack” can make the rake less strenuous to use.

Typical rakes of the push or push and pull type have been shown, for example, in the following, mainly United States of America patents:

| | | |
|---|---|---|
| CA,195,740 | Gibbs | 1920 |
| CA,427,725 | Fetterman | 1944 |
| 4,603,407 | Tansey | 1977 |
| 4,219,993 | Cosmos | 1980 |
| 4,516,393 | Lambert | 1985 |
| 4,520,621 | Archer | 1985 |
| 4,644,740 | Lee | 1987 |
| D,306,682 | Thompson | 1990 |
| 4,970,853 | Greene, III | 1990 |
| 4,901,801 | Popivalo | 1990 |
| 5,069,026 | Johnson | 1991 |
| 5,509,259 | Milbury | 1996 |

Although there have been many of inventions (some noted above) that provide for a rake that can be used in a push operation or ones that can be used in both the push or pull operation, there has been a continued need for improvement. Many rely on mechanisms such as wheels to keep the rake tines above the soil and on others the tines are rigid and are not able to provide a proper rake action that is necessary for a good cleaning job. In some designs there exist two sets of tines, one for pushing and one for pulling making the rake more awkward to use or making it necessary for the user to carry extra weight around at all times.

It is the intention of this invention to provide a lawn rake that can be used as a pull rake and a push rake that can achieve both with the minimum amount of parts.

It is a further intention of this invention to provide an adjustment device on the rake that will enable the rake to be converted from a pull rake to a push rake with a simple adjustment and not requiring a duplication of parts for both operations.

It is a more specific intention of this invention to provide a rake whereby the rake head is divided into two segments and the two segments are connected by a hinged device to enable the rake to convert from a pull rake to a push rake and have a number of positions to which it can be adjusted.

It is a further intention of this invention to be able to convert the operation of the rake from a pull operation to a push operation in such a way that the same set of tines interact with the ground and that the angle and manner in that the tines of the rake interact with the ground remains the same, that is, the same set of tines perform both the pull or push raking action.

It is a further intention of this invention to provide a rake that can be adjusted for the individual user in both the push and the pull position, allowing each user to adjust the “angle of attack” for maximum efficiency and maximum comfortable position.

It is another intention of this invention to provide a rake that is very efficient in yard and leaf cleaning in that it can be used as a pull rake in areas where only a pull rake can be used and can also be used as a push rake in the open areas where this operation is less strenuous on the user, resulting is a thorough cleaning of the lawn or yard and minimizing the amount of time required to complete the work.

It is a further intention of this invention to provide an adjustable apparatus that is connected to the lower portion of the rake head and the handle of the rake in such a way that the device can be moved along and be fixed in place on the handle by means of a screw or lever type device. This apparatus is the means by which the rake is converted from a pull rake to a push rake. This apparatus is also the means by which the tines are braced against the raking motion.

### DRAWINGS

In the drawings, which form part of this specification,

FIG. 1 is a front view of the entire rake

FIG. 2 is a side view of the entire rake

FIG. 3 is a back view of the entire rake

FIG. 4 is an enlarged front partial view of the rake

FIG. 5 is an enlarged side partial view of the rake

FIG. 6 is an enlarged rear partial view of the rake

FIG. 7 is a view showing the entire rake in a push operation mode and the entire rake converted to a pull operation mode.

FIG. 8 is larger partial view of the rake in the pull mode

FIG. 9 is a larger partial view of the rake in the push mode.

FIG. 10 shows the full range of the adjustability of the rake

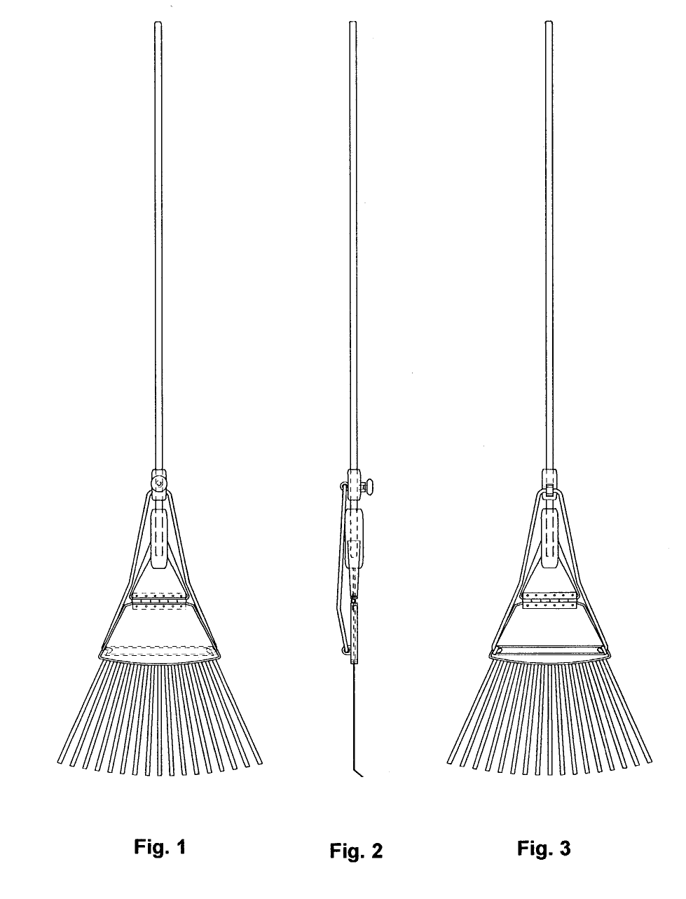

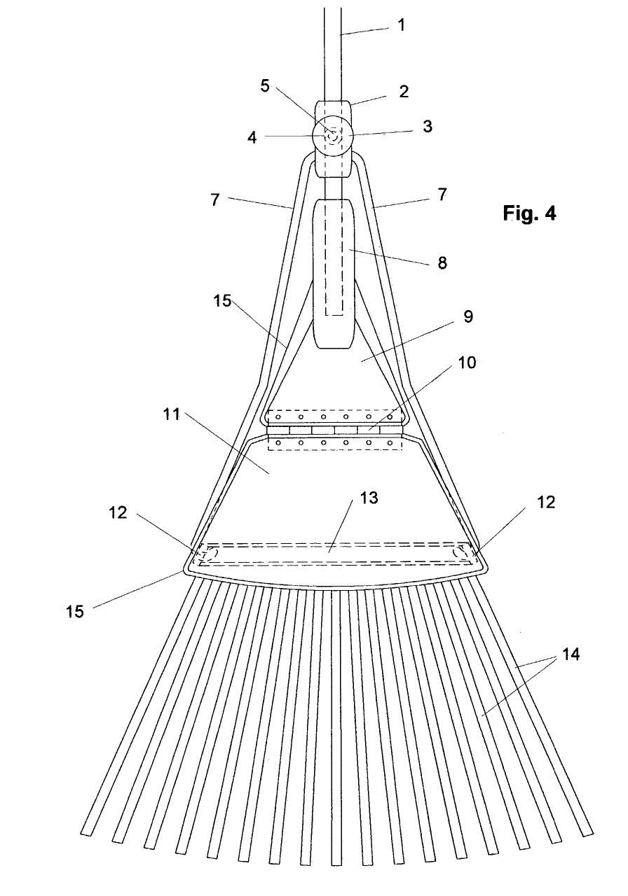

### DETAILED DESCRIPTION OF THE INVENTION

Referring now to FIGS. 4, 5 and 6 of the drawings depicting a preferred embodiment of the invention, the rake comprises of an elongated handle 1 which has two ends and is most suitably a wooden handle. One end of handle 1 is inserted into a collar 8 that is a part of and attached to upper frame section 9 of the rake head.

The upper frame section 9 of the rake head is generally a triangular shape that is flat and has reinforced sides 15. The collar 8 forms the top part of the upper frame section 9.

The upper frame 9 of the rake head is attached by means of a hinge 10 to a lower section frame 11 of the rake head. It is contemplated that the hinge will be made of metal. The lower section frame 11 of the rake read is generally a rectangular shape with uneven sides at the top of which is attached hinge 10 and an the bottom of the lower section frame 11 is attached a plurality of tines 14. The lower section frame 11 has reinforced edges 15 as does the upper frame section 9.

The upper end of the upper frame section 9 of the rake head is attached by means of hinge 10 to the lower part of the upper frame section 9 of the rake head.

Although the tines 14 of the rake head can be made of other suitable material, such as flexible steel, it is presently contemplated that they will be made of plastic (flat type or rod type). It is also envisioned that collar 8, upper frame section 9 and lower frame section 11 will also be made of plastic, even though other materials will be suitable. It is also presently contemplated that the tines will be adhesively secured to the lower frame section 11 but other means of securement can be utilized.

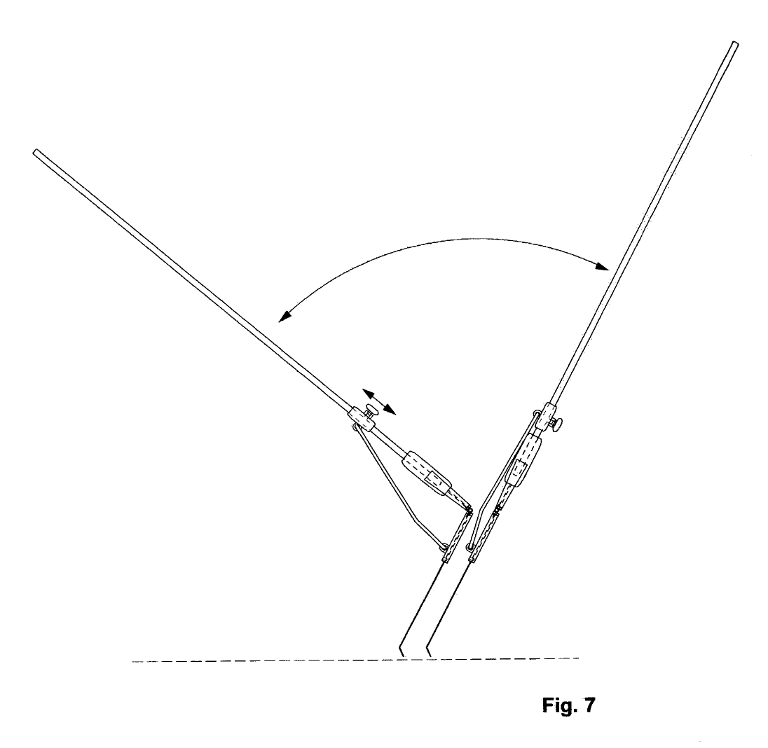

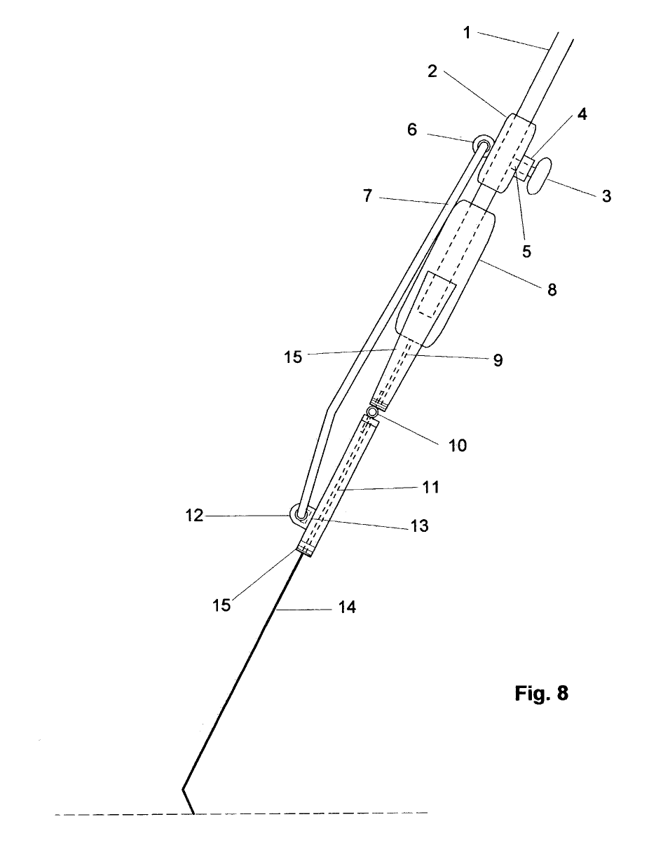

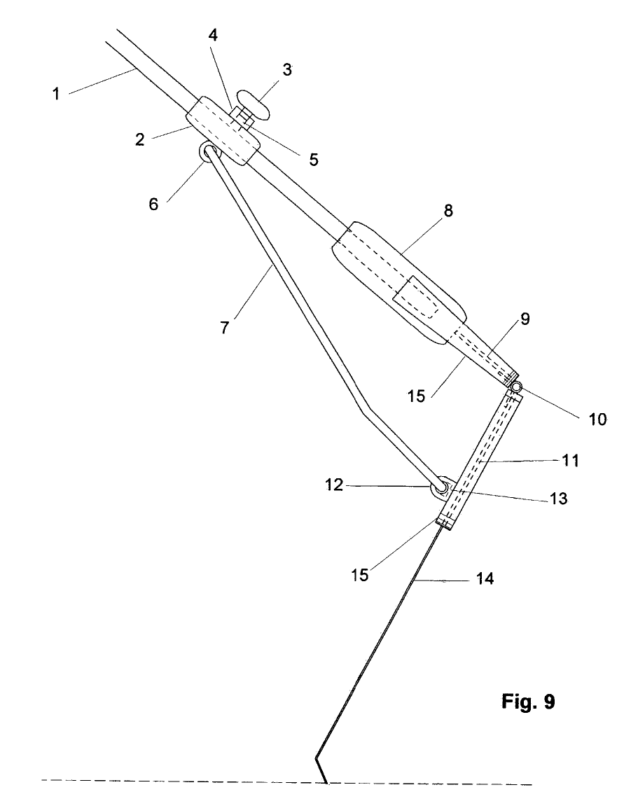

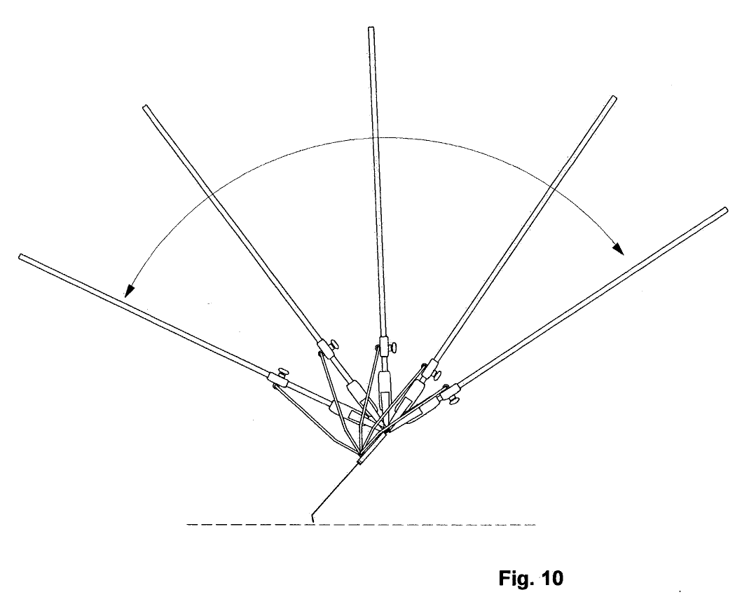

The means by which the rake is transformed from a pull rake to a push rake is described best in FIGS. 7, 8, and 9. Along handle 1 and above collar 8, is fitted a sleave 2 that is snug to the handle but is free to move up and down handle 1. At the front part of sleave 2 is fitted a screw bolt type device 5 that rotates inside a bolt nut type device 4. The screw bolt is turned by means of a knob 3. The knob 3 is fixed to the screw bolt type device 5 to facilitate the tightening of sleave 2 to handle 1 at various locations.

Attached to the back of sleave 2 is a ring type attachment 6 which is used to secure one end the metal brace rods 7. The other end of metal brace rods 7 are attached to the lower frame section 11 of the rake head by means of passing the ends of the brace rods through holes 12 at each end of a stiffening cross brace 13 attached to the back of the lower frame section 11 of the rake head. The brace rods, made of ⅜″ steel rod, are snugly fitted in holes 12 and the ends of said rods are bent so that they cannot easily become dislodged.

As shown in FIG. 10, the adjusting and brace apparatus described above makes it possible to change the angle of said lower frame section 11 and said tines 14 in relation to said handle 1 with the pivoting point being hinge 10. A full range of adjustment is possible as also shown in FIG. 10. In the pull rake position, sleave 2 is closest to collar 8 of the upper frame section 9 of the rake head . As the sleave moves up handle 1 of the rake, the tines 14 are no longer in a straight line with the handle 1 and the rake can be adjusted to whatever angle is comfortable to the user for the push or pull raking operation. A slight adjustment to the angle of the tines 14 in relation to the handle 1 can also make the pulling operation of the rake more efficient is that the rake can be operated in a more comfortable standing position.

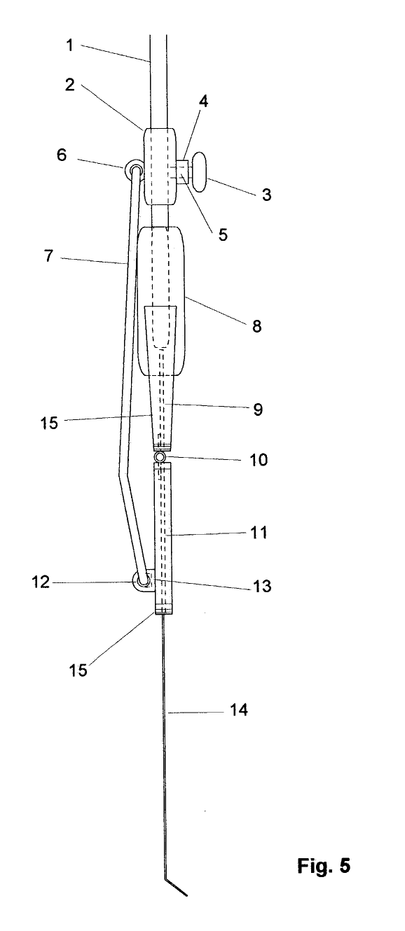

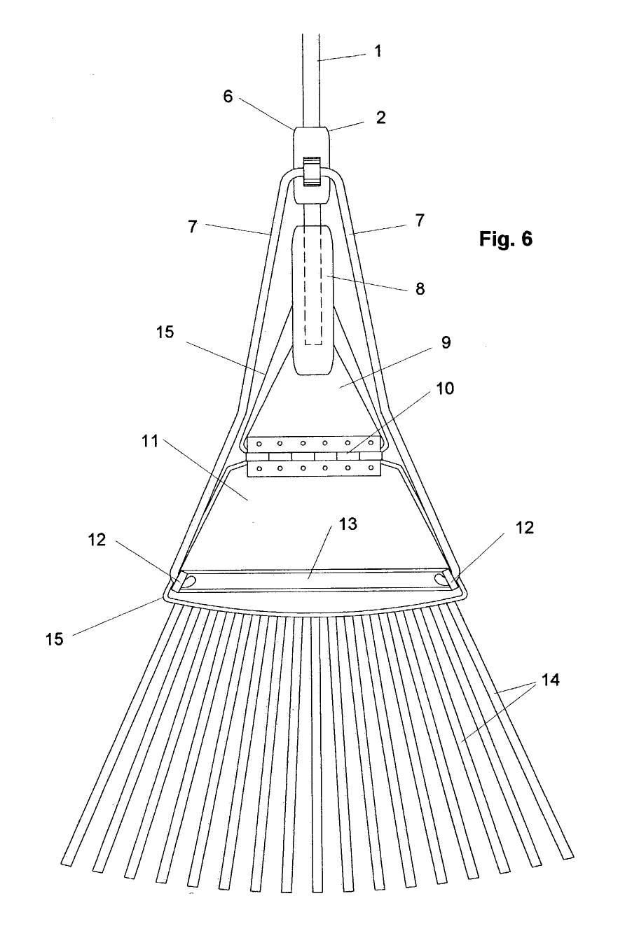

As shown in FIG. 5, the brace rods 7 are shaped and bent to best provide a rigid support for the lower frame section 11 and tines 14 in both the push and pull position of the rake. In the push position of the rake, the brace rods 7 provide the resistance that keeps the tines from bending backwards.

The embodiments of the invention in which an exclusive property or privilege is claimed are defined as follows:

1. A raking device that can, with little effort, be converted from a pull rake type to a push rake type comprising:
an elongated handle member that is round and having a first and second end for pushing and pulling the raking device.
an upper frame section of the rake head that is generally triangular in shape, and has a front, sides, bottom, and top; and has reinforced edges. At the top there is a collar type receptacle for receiving one end of the handle member. At the bottom of the upper frame section of the rake heat is a hinge device that connects the upper frame section of the rake head to a lower frame section of the rake head.
a hinge type device that connects the top and bottom frame sections of the rake head, allowing the two sections to interact at various angles to each other.
a lower frame section of the rake head that is generally rectangular in shape with all sides being of different dimensions. The bottom frame section is generally flat and has a front, back, sides, bottom and top; with the edges being reinforced. At the top of the lower frame section of the rake head is attached the hinge device that connects the lower frame section of the rake head to the upper frame section of the rake head; the hinge device enables the lower frame section of the rake head to be rotated to a plurality of angles in relation to the upper frame section and the handle of the rake.
an array of tines which are arranged so as to project from the bottom end of the lower frame section of the rake frame head.
an adjusting device consisting of two ends. One end of which is in a form of a sleave that can freely move up and down along the rake handle unless it is fixed in place and restrained from moving, and the other end is attached to the lower frame of the rake head by means of brace rods that are connected to holes at each side of the lower rake section of the rake head.
the holes are at each end of a stiffening bar attached to the back of the lower rake section of the rake head. The stiffening bar is attached to the back side of the lower frame section of the rake head provides rigidity to said lower section of the rake head and tines during the raking action.
at the front of the sleave is attached a bolt type device consisting of two ends; to one end of the bolt type device is attached to a knob such that the bolt type device can be turned by turning the knob.
by turning the knob, the bolt type device is caused to be turned tight onto the handle and as a result, the movement of the sleave along the handle is restrained; the sleave can be moved along and can be fixed, by tightening of the knob, to any location along handle that the adjustment device can reach when the angle of the rake frame sections, in relation to each other, is changed.
to the back of the sleave is fixed a ring type section which receives the top part of the brace and adjustment rods. The brace rods are also attached to the lower frame section of the rake head as already describe.
the ends of the rods are bent in such a way that the ends do not easily slip out of the holes located on each side of the lower fame section of the rake head; the rods are also bent in a profile to give maximum support to the lower frame section of the rake head and the tines of the rake.
an array of flexible tines are attached to the lower frame section of the rake head; the tines generally operate in the same direction in relation the raking action and the ground, whether the raking device is being pulled or being pushed.

2. The adjustable raking device of claim 1, wherein the said handle can be made from wood, metal or plastic.

3. The adjustable raking device of claim 1, wherein the said upper and lower rake frame sections can be made from plastic, metal or other suitable material.

4. The adjustable raking device of claim 1, wherein the said tines can be made from plastic, metal rods or other suitable material.

5. The adjustable raking device of claim 1, wherein the said tines can be made from plastic or metal flat lengths.

6. The adjustable raking device of claim 1, where in the said sleave restricting device can be a lever type device which when lever is operated, pressure is placed against the handle of the rake and thereby preventing the sleave from moving along the handle once the desired angle is determined.

7. The adjustable raking device of claim 1, wherein the said adjustment device comprises of more than two metal rods that are attached to the sleave and the stiffening brace at the back of the lower frame section.

8. The adjustable raking device of claim 1, wherein the said holes that receive the ends of the brace rods at the lower frame section of the rake head consist of bracket attached to each side of the lower frame section of the rake head.

9. The adjustable raking device of claim 1, wherein the handle of the rake is protected from wear each time the restricting device is tightened onto the handle.

10. The adjustable raking device of claim 1, wherein the said hinge device can be in the form of a flexible metal or plastic section attached to the upper and lower frame sections of the rake head.

11. The adjustable raking device of claim 1, wherein an attachment can be added to the lower section of the rake head to increase the area/size of the rake head in the push mode.
